(19) United States
(12) Patent Application Publication
(10) Pub. No.: US 2019/0131052 A1
(43) Pub. Date: May 2, 2019

(54) REACTOR

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Kazushi KUSAWAKE, Yokkaichi-shi (JP); Shintaro NANBARA, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/094,431

(22) PCT Filed: Apr. 6, 2017
(86) PCT No.: PCT/JP2017/014404

§ 371 Date: Oct. 17, 2018

(30) Foreign Application Priority Data
Apr. 26, 2016 (JP) 2016-088447
Aug. 26, 2016 (JP) 2016-166239

(51) Int. Cl. H01F 27/02; H01F 27/28; H01F 27/24

(52) U.S. Cl. CPC H01F 27/025; H01F 27/24; H01F 27/2823

(57) ABSTRACT

A reactor includes: a combined body formed by combining a coil, with a magnetic core; and a case for accommodating the combined body. The wire-wound portion has a case-opposing face that is at least a portion of an outer peripheral face of the wire-wound portion, and opposes an inner wall face of the case, and when it is assumed that a bottom face side of the case is a lower side, and a side opposite to the lower side is an upper side, the wire-wound portion is formed so that one of an end portion of the case-opposing face on the lower side and an end portion of the case-opposing face on the upper side is closer to the center of the wire-wound portion than the other one of the end portion of the case-opposing face on the lower or the upper side.

### TECHNICAL FIELD

The present disclosure relates to a reactor.

This application claims priority of Japanese Patent Application No. 2016-88447 filed Apr. 26, 2016 and Japanese Patent Application No. 2016-166239 filed Aug. 26, 2016, the entirety of which is incorporated herein by reference.

### BACKGROUND ART

For example, Patent Document 1 discloses a reactor that is used in a converter for electric vehicles, such as a hybrid automobile.

Patent Document 1 discloses a reactor that includes a combined body configured by combining a coil that has a pair of wire-wound portions with a magnetic core, a portion of which is arranged within the wire-wound portions, and a case that accommodates the combined body.

### CITATION LIST

### Patent Documents

Patent Document 1: JP 2007-305803A

### SUMMARY

A reactor according to this disclosure is a reactor including:

a combined body formed by combining a coil that has a wire-wound portion, with a magnetic core; and

a case for accommodating the combined body therein,

wherein the wire-wound portion has a case-opposing face that is at least a portion of an outer peripheral face of the wire-wound portion, and opposes an inner wall face of the case, and

when it is assumed that a bottom face side of the case is a lower side, and a side opposite to the lower side is an upper side, the wire-wound portion is formed so that one of an end portion of the case-opposing face on the lower side and an end portion of the case-opposing face on the upper side is closer to the center of the wire-wound portion than the other one of the end portion of the case-opposing face on the lower side and the end portion of the case-opposing face on the upper side.

### BRIEF DESCRIPTION OF DRAWINGS

FIG. 1 is a schematic perspective view of a reactor that includes a coil with a pair of wire-wound portions according to Embodiment 1.

FIG. 2 is an exploded perspective view of a combined body of the reactor according to Embodiment 1.

FIG. 3 is a schematic diagram illustrating a positional relationship between the wire-wound portions and inner wall faces of a case in the reactor according to Embodiment 1.

FIG. 4 is a schematic diagram illustrating a positional relationship between wire-wound portions and inner wall faces of a case in a reactor according to Embodiment 2.

FIG. 5 is a schematic diagram illustrating a positional relationship between wire-wound portions and inner wall faces of a case in a reactor according to Embodiment 3.

FIG. 6 is a schematic diagram illustrating a positional relationship between wire-wound portions and inner wall faces of a case in a reactor according to Embodiment 4.

FIG. 7 is a schematic diagram illustrating a positional relationship between wire-wound portions and inner wall faces of a case in a reactor according to Embodiment 5.

FIG. 8 is an exploded perspective view of a combined body of a reactor that includes a coil with one wire-wound portion according to Embodiment 6.

FIG. 9 is a schematic diagram illustrating a positional relationship between the wire-wound portion and inner wall faces of a case in the reactor according to Embodiment 6.

FIG. 10 is a schematic diagram illustrating a positional relationship between a wire-wound portion and inner wall faces of a case in a reactor according to Embodiment 7.

FIG. 11 is a schematic diagram illustrating a positional relationship between wire-wound portions and inner wall faces of a case, and a positional relationship between the wire-wound portions and outer peripheral faces of internal core portions in a reactor according to Embodiment 8.

FIG. 12 is a schematic diagram illustrating a positional relationship between wire-wound portions and inner wall faces of a case, and a positional relationship between the wire-wound portions and outer peripheral faces of internal core portions in a reactor according to Embodiment 9.

FIG. 13 is a cross-sectional view taken along a line XIII-XIII in FIG. 12.

### DESCRIPTION OF EMBODIMENTS

### Problem to be Solved by this Disclosure

With recent development of electric vehicles, there is a demand to improve the performance of reactors. For example, there is a demand to suppress a change in magnetic characteristics of reactors due to heat accumulated therein, by improving the heat dissipation properties of the reactors. The configuration of reactors has been reviewed for this reason.

This disclosure aims to provide a reactor with good heat dissipation properties.

### Advantageous Effect of this Disclosure

The reactor has good heat dissipation properties.

### DESCRIPTION OF EMBODIMENTS

First, modes for carrying out a preferred embodiment will be listed and described.

<1> A reactor according to an embodiment is a reactor including:

a combined body formed by combining a coil that has a wire-wound portion, with a magnetic core; and

a case for accommodating the combined body therein,

wherein the wire-wound portion has a case-opposing face that is at least a portion of an outer peripheral face of the wire-wound portion, and opposes an inner wall face of the case, and

when it is assumed that a bottom face side of the case is a lower side, and a side opposite to the lower side is an upper side, the wire-wound portion is formed so that one of an end portion of the case-opposing face on the lower side and an end portion of the case-opposing face on the upper side is closer to the center of the wire-wound portion than the other one of the end portion of the case-opposing face on the lower side and the end portion of the case-opposing face on the upper side.

In the case where the inner wall face of the case is perpendicular to the bottom face, one end portion of the case-opposing face that is closer to the center of the wire-wound portion is more distant from the inner wall face of the case than the other end portion. That is to say, a relatively large space is formed near the one end portion in the case. In the case of filling the case with potting resin or the like, the aforementioned space allows the potting resin to readily spread within the case, and cavities are unlikely to be formed in the potting resin. Cavities in potting resin may be a factor in a decrease in the efficiency of dissipating heat from the wire-wound portion to the case. A reactor in which cavities are unlikely to be formed in potting resin has good heat dissipation properties. Heat is unlikely to accumulate within a reactor with good heat dissipation properties when in use, and thus, a situation is unlikely to occur where magnetic characteristics of the reactor change due to heat and the reactor operates unstably.

<2> A reactor according to an embodiment may employ a mode in which

the inner wall face of the case has a coil-opposing face that opposes the case-opposing face of the wire-wound portion, and

the coil-opposing face has a shape that is formed following the shape of the case-opposing face.

If the shape of the coil-opposing face of the inner wall face of the case is formed following the shape of the case-opposing face of the wire-wound portion, the distance from any position on the case-opposing face to the coil-opposing face is substantially fixed. That is to say, a heat dissipation path from any position on the case-opposing face to the coil-opposing face has a substantially fixed length, and it is thus possible to reduce unevenness in heat dissipation from the wire-wound portion, and improve the heat dissipation properties of the reactor.

<3> A reactor according to an embodiment may employ a mode in which

the wire-wound portion is formed so that the end portion of the case-opposing face on the lower side is closer to the center of the wire-wound portion than the end portion of the case-opposing face on the upper side.

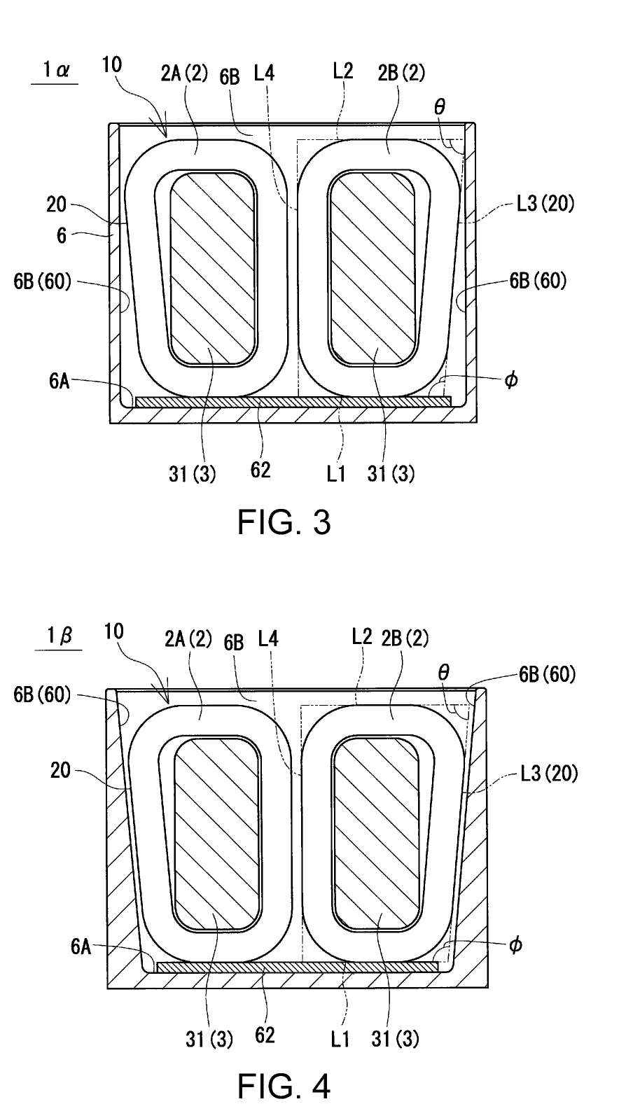

In the above-described configuration, the shape of the wire-wound portion within the case when viewed from a side is an inverted trapezoidal shape (a shape that is similar to a trapezoid with a lower side narrower than an upper side). In the case of this configuration, the combined body can be readily arranged within the case if the inner wall face of the case is formed to be perpendicular to the bottom face as shown in FIG. 3 for the later-described Embodiment 1, or to expand further outward on the upper side as shown in FIG. 4 for Embodiment 2.

<4> A reactor according to an embodiment may employ a mode in which

the wire-wound portion is formed so that the end portion of the case-opposing face on the upper side is closer to the center of the wire-wound portion than the end portion of the case-opposing face on the lower side, and

the case includes a bottom plate portion that constitutes the bottom face, and a side wall portion that has a tubular shape and is attached to the bottom plate portion.

In the above-described configuration, the shape of the wire-wound portion within the case when viewed from a side is a trapezoidal shape (a shape that is similar to a trapezoid). In the case of this configuration, when the combined body is accommodated within the case from an upper opening portion of a box-shaped case, there is a concern that the coil (particularly, the wire-wound portion) will come into contact with the inner wall face of the case on the upper opening side of the case. For this reason, it is favorable that the case has a divided structure constituted by the bottom plate portion and the side wall portion. With the case that has a divided structure, the combined body can be covered with the side wall portion from thereabove after being placed on the bottom plate, as shown in FIG. 6 for the later-described Embodiment 4. Thus, contact between the wire-wound portion in the combined body and the inner wall face of the case can be suppressed.

<5> A reactor according to an embodiment may employ a mode in which

the coil includes one wire-wound portion,

an end face of the wire-wound portion on one end side in an axial direction thereof is arranged opposing the inner wall face of the case, and the shape of the wire-wound portion when viewed from the end face side on the one end side is an isosceles trapezoidal shape that includes a lower side opposing the bottom face of the case, an upper side parallel to the lower side, and a pair of outer sides that connect the lower side to the upper side and face the inner wall face of the case.

In this configuration, the wire-wound portion is horizontally arranged within the case. In other words, the axis of the wire-wound portion is substantially parallel to the bottom face of the case. Also, in this configuration, the shape of the wire-wound portion when viewed from an end face side is a trapezoidal shape or an inverted trapezoidal shape. Here, a corner portion of the trapezoid in this configuration is formed by bending a winding wire, and thus, the actual corner portion of the trapezoid is rounded. This configuration can achieve the same effects as those of <1> above.

<6> A reactor according to an embodiment may employ a mode in which

the coil includes a pair of the wire-wound portions that are arranged parallel to each other,

an end face of each of the wire-wound portions on one end side in an axial direction thereof is arranged opposing the inner wall face of the case, and

the shape of each of the wire-wound portions when viewed from the end face side on the one end side is a right trapezoidal shape that includes a lower side opposing the bottom face of the case, an upper side parallel to the lower side, an outer side that connects the lower side to the upper side and faces the inner wall face of the case, and an inner side that connects the lower side to the upper side on a side opposite to the outer side.

In this configuration as well, the wire-wound portions are horizontally arranged within the case. In other words, the axes of the wire-wound portions are substantially parallel to the bottom face of the case. Also, in this configuration, the shape of the wire-wound portions when viewed from an end face side is a trapezoidal shape or an inverted trapezoidal shape. A corner portion of the trapezoid in this configuration is also formed by bending a winding wire, and thus, the actual corner portion of the trapezoid is rounded. This configuration can achieve the same effects as those of <1> above.

<7> A reactor according to an embodiment may employ a mode in which

the coil includes one wire-wound portion,

an end face of the wire-wound portion on one end side in an axial direction thereof is arranged opposing the bottom face of the case, and

the shape of the wire-wound portion when viewed from a direction perpendicular to the axial direction thereof is an isosceles trapezoidal shape that includes a lower side opposing the bottom face of the case, an upper side parallel to the lower side, and a pair of outer sides that connect the lower side to the upper side and face the inner wall face of the case.

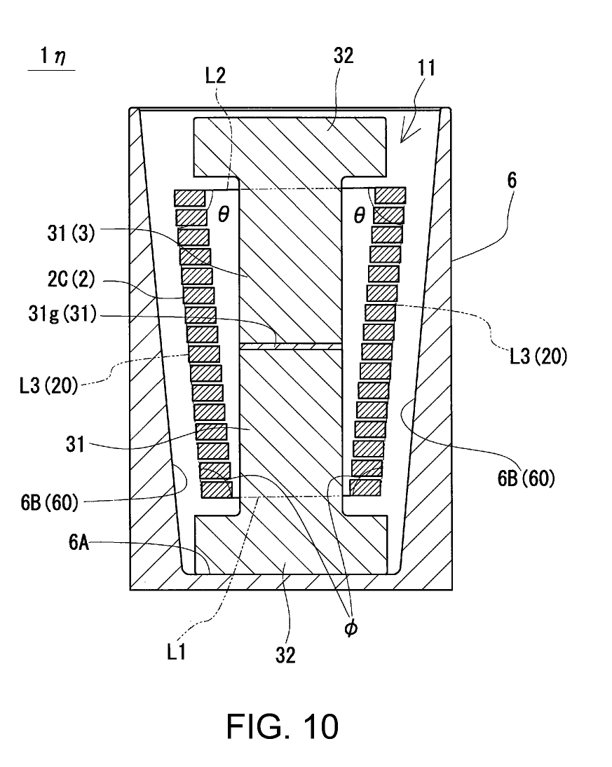

In this configuration, the wire-wound portion is vertically arranged within the case. In other words, the axis of the wire-wound portion is substantially perpendicular to the bottom face of the case. In this configuration, the shape of the wire-wound portion when viewed from a peripheral face side is a trapezoidal shape or an inverted trapezoidal shape. Here, outer sides that constitute the trapezoid are formed with outer peripheral portions of respective turns of the wire-wound portion gradually shifting. For this reason, the actual outer sides are formed to have a stair-like shape, as shown in FIG. 10 for the later-described Embodiment 7. This configuration can achieve the same effects as those of <1> above.

<8> A reactor according to an embodiment may employ a mode in which

the coil includes a pair of the wire-wound portions that are arranged parallel to each other,

an end face of each of the wire-wound portions on one end side in an axial direction thereof is arranged opposing the bottom face of the case, and

the shape of each of the wire-wound portions when viewed from a direction perpendicular to the axial direction thereof is a right trapezoidal shape that includes a lower side opposing the bottom face of the case, an upper side parallel to the lower side, an outer side that connects the lower side to the upper side and faces the inner wall face of the case, and an inner side that connects the lower side to the upper side on a side opposite to the outer side.

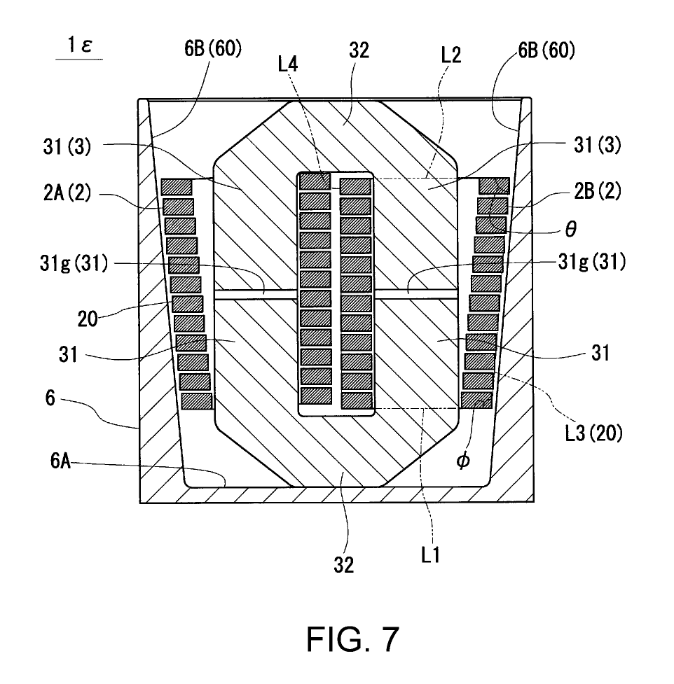

In this configuration, the wire-wound portions are vertically arranged within the case. In other words, the axes of the wire-wound portions are substantially perpendicular to the bottom face of the case. In this configuration, the shape of the wire-wound portions when viewed from a peripheral face side is a trapezoidal shape or an inverted trapezoidal shape. The actual outer sides of the trapezoid in this configuration are also formed with outer peripheral portions of respective turns of each wire-wound portion, and thus, the actual outer sides are formed to have a stair-like shape, as shown in FIG. 7 for the later-described Embodiment 5. This configuration can achieve the same effects as those of <1> above.

<9> A reactor according to an embodiment in which the wire-wound portion within the case when viewed from a direction parallel to the bottom face has a trapezoidal shape may employ a mode in which

one of the angle between the upper side and the outer side and the angle between the lower side and the outer side is an obtuse angle that is 91° or larger and 95° or smaller.

With the above-described configuration, the shape of the wire-wound portion is not excessively distorted, and this wire-wound portion has almost the same magnetic characteristics as those of a wire-wound portion that is rectangular when viewed from a side.

<10> A reactor according to an embodiment may employ a mode in which

the magnetic core includes an internal core portion arranged within the wire-wound portion,

an end face of the wire-wound portion on one end side in an axial direction thereof is arranged opposing the inner wall face of the case, and

a cross-sectional shape of the internal core portion in an imaginary cross section perpendicular to an axis of the wire-wound portion is a shape that is similar to the shape made by an inner outline of the wire-wound portion in the imaginary cross section.

In a configuration in which the wire-wound portion is horizontally arranged within the case, if the shape of a cross section the internal core portion that is perpendicular to the axis of the wire-wound portion is formed following the inner outline of the wire-wound portion, the distance from any position on the outer peripheral faces of the internal core portion to the inner peripheral face of the wire-wound portion can be made the same. That is to say, since a heat dissipation path from any position on the outer peripheral face of the internal core portion to the wire-wound portion has a substantially fixed length, it is possible to reduce unevenness in heat dissipation from the internal core portion, and improve the heat dissipation properties of the reactor.

<11> A reactor according to an embodiment may employ a mode in which

the magnetic core includes an internal core portion arranged within the wire-wound portion,

an end face of the wire-wound portion on one end side in an axial direction thereof is arranged opposing the bottom face of the case, and

a cross-sectional shape of the internal core portion in an imaginary cross section perpendicular to the end face on the one end side is a shape that is similar to the shape made by an inner outline of the wire-wound portion in the imaginary cross section.

In a configuration in which the wire-wound portion is vertically arranged within the case, if the shape of a cross section of the internal core portion that is perpendicular to the end face on the one end side of the wire-wound portion is formed following the inner outline of the wire-wound portion, the distance from any position on the outer peripheral faces of the internal core portion to the inner peripheral face of the wire-wound portion can be made the same. That is to say, since a heat dissipation path from any position on the outer peripheral face of the internal core portion to the wire-wound portion has a substantially fixed length, it is possible to reduce unevenness in heat dissipation from the internal core portion, and improve the heat dissipation properties of the reactor.

### DETAILS OF EMBODIMENTS

Hereinafter, an embodiment of a reactor will be described based on the drawings. The same signs in the drawings denote items with the same names. Note that the present invention is not limited to configurations described in the embodiments but is defined by the claims, and is intended to include all modifications made within the scope and meaning equivalent to the claims.

### Embodiment 1

### Overall Configuration

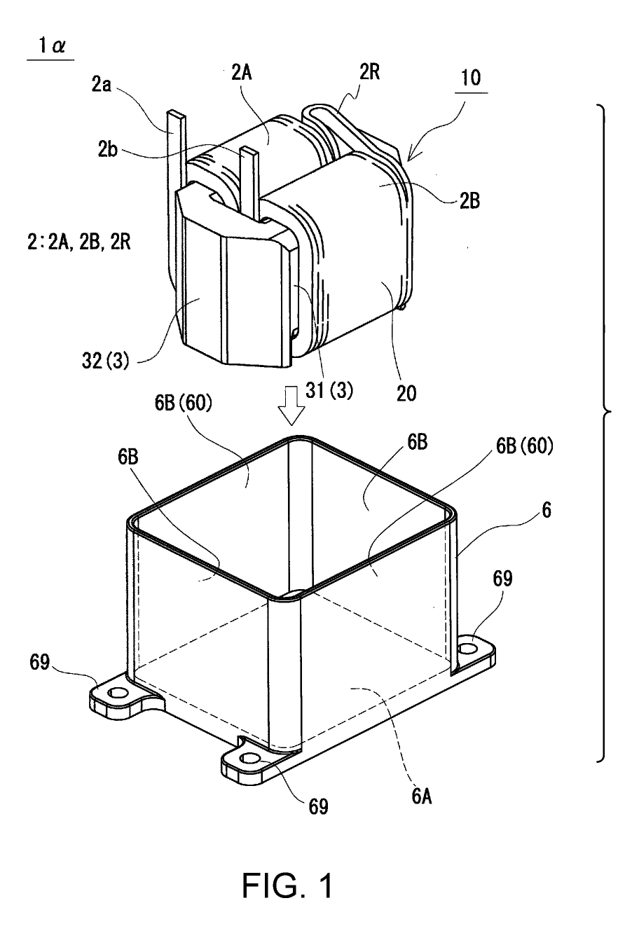

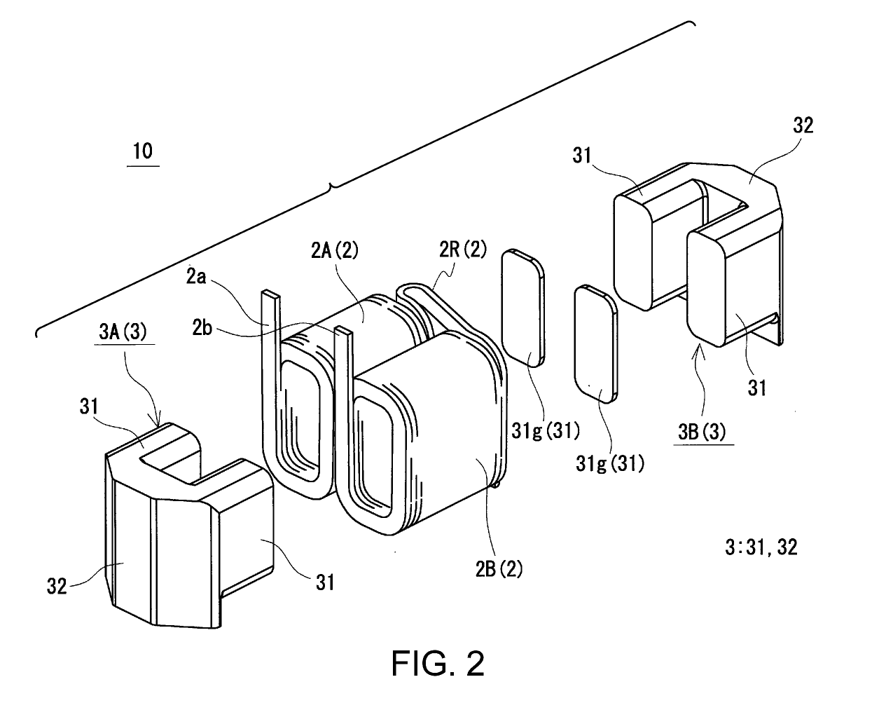

A reactor 1α shown in FIGS. 1 to 3 has a configuration in which a combined body 10 that has a coil 2 and a magnetic core 3 is accommodated in a case 6. In the configuration in this example, the inside of the case 6 is filled with a potting resin, which is not shown in the diagram. Features of this reactor 1α include the shape of wire-wound portions 2A and 2B of the coil 2. The shape of the wire-wound portions 2A and 2B is determined while giving consideration to the positional relationship between the wire-wound portions 2A and 2B and inner wall faces 6B of the case 6. Accordingly, constituent elements of the reactor 1α will be briefly described first based on FIGS. 1 and 2, and then a detailed description will be given, with reference to FIG. 3, of the shape of the wire-wound portions 2A and 2B, as well as the positional relationship between the wire-wound portions 2A and 2B and the case 6.

### Combined Body

The combined body 10 will be described, mainly with reference to FIG. 2.

### Coil

The coil 2 according to this embodiment includes a pair of wire-wound portions 2A and 2B that are arranged in parallel, and a connecting portion 2R that connects the wire-wound portions 2A and 2B to each other. End portions 2a and 2b of the coil 2 are pulled out from the wire-wound portions 2A and 2B, and are connected to terminal members, which are not shown in the diagrams. An external device, such as a power supply for supplying power to the coil 2, is connected thereto via these terminal members. The wire-wound portions 2A and 2B included in the coil 2 are each formed to have a substantially rectangular tubular shape with the same winding number and the same winding direction, and are arranged so that their axial directions are parallel to each other. The connecting portion 2R connects the wire-wound portions 2A and 2B to each other, and is bent in a U shape. This coil 2 may be formed by helically winding a single winding wire that has no joint portion, or may be formed by making the wire-wound portions 2A and 2B using separate winding wires, and joining end portions of the winding wires of the wire-wound portions 2A and 2B to each other by means of welding or crimping, for example.

The coil 2 that includes the wire-wound portions 2A and 2B can be constituted by a coated wire that has an insulating coating, which is made of an insulating material, on the outer periphery of a conductor, which is, for example, a flat wire or a round wire that is made of a conductive material such as copper, aluminum, magnesium, or an alloy of these materials. In this embodiment, the wire-wound portions 2A and 2B are each formed by edge-wise winding a coated flat wire constituted by a conductor that is a copper flat wire and an insulating coating that is made of enamel (typically, polyamidimide).

### Magnetic Core

The configuration of the magnetic core 3 is not particularly limited, and may be a known configuration. The magnetic core 3 in this example is configured by combining two divided cores 3A and 3B, each of which is substantially U-shaped when viewed from above. The magnetic core 3 can be divided into internal core portions 31 and external core portions 32, for convenience.

The internal core portions 31 are arranged within the wire-wound portions 2A and 2B of the coil 2. Here, the internal core portions 31 refer to portions of the magnetic core 3 that extend in the axial directions of the wire-wound portions 2A and 2B of the coil 2. For example, in this example, ends of portions of the internal core portions 31 that extend in the axial direction protrude outward from end faces of the wire-wound portions 2A and 2B as shown in FIG. 1, and these protruding portions are also included in the internal core portions 31.

Each of the internal core portions 31 in this example is constituted by one of the protruding portions of the U shape of the divided core 3A, one of the protruding portions of the U shape of the divided core 3B, and a plate-shaped gap portion 31g that is arranged between these protruding portions. The gap portions 31g are made of a non-magnetic material, such as alumina. The shape of each internal core portion 31 corresponds to the internal shape of the wire-wound portion 2A (2B), and is a substantially rectangular parallelepiped shape in this example. Note that the gap portions 31g may be omitted.

Meanwhile, the external core portions 32 are arranged outside the wire-wound portions 2A and 2B, and have a shape that connects end portions of the pair of internal core portions 31. Each of the external core portions 32 in this example is configured as a root portion of the U shape of the divided core 3A (3B). Lower faces of the external core portions 32 are substantially flush with lower faces of the wire-wound portions 2A and 2B of the coil 2.

The divided cores 3A and 3B are powder compacts that are formed by pressure-molding raw powder that contains soft magnetic powder. To ensure insulation between the divided cores 3A and 3B (magnetic core 3) and the coil 2, a configuration may also be employed in which molding resin is provided on the outer periphery of the powder compacts, or an insulating interposing member that is separate from the divided cores 3A and 3B is interposed between the divided cores 3A and 3B and the wire-wound portions 2A and 2B of the coil 2. The soft magnetic powder contained in the powder compact is an aggregate of magnetic particles that are made of an iron group metal such as iron, or an alloy thereof (Fe—Si alloy, Fe—Ni alloy etc.), for example. An insulating coating that is made of phosphate or the like may also be formed on the surface of the magnetic particles. The raw powder may also contain a lubricant. The molding resin may be any of thermoplastic resin, which includes polyphenylene sulfide (PPS) resin, polytetrafluoroethylene (PTFE) resin, liquid crystal polymer (LCP), polyamide (PA) resin such as nylon 6 or nylon 66, polybutylene terephthalate (PBT) resin, and acrylonitrile-butadiene-styrene (ABS) resin, for example. The molding resin may also be any of thermosetting resin, which includes unsaturated polyester resin, epoxy resin, urethane resin, and silicone resin. The heat dissipation properties of the molding resin may be improved by including a ceramic filler, such as alumina or silica, in such a molding resin. Here, instead of forming the molding resin at the periphery of the powder compact, an insulating interposing member that is interposed between the coil 2 and the magnetic core 3 may be provided. An example of a configuration using an insulating interposing member will be described later in Embodiment 8.

Unlike this example, the divided cores 3A and 3B may also be constituted by a molded body of a composite material that contains soft magnetic powder and resin. The soft magnetic powder in the composite material may be the same as a soft magnetic powder that can be used in the powder compacts. The resin may be any of thermosetting resin, which includes epoxy resin, phenol resin, silicone resin, and urethane resin, or thermoplastic resin, which includes PPS resin, PA resin such as nylon 6 or nylon 66, polyimide resin, and fluororesin, for example. An example of a configuration using the composite material will be described later in Embodiment 9.

### Case

The case 6 is a tubular member with a bottom for accommodating the combined body 10, as shown in FIG. 1. The case 6 in this example is provided with four fixing portions 69 (only three of which can be seen in FIG. 1), which protrude outward of the case 6. The fixing portions 69 are members for fixing the case 6 to an installation target, such as a cooling base, and screw holes are formed therein in this example.

The case 6 is required to have a function of not only protecting the combined body 10, but also dissipating, to the installation target, heat generated in the combined body 10 when the reactor 1α is used. For this reason, the case 6 is required to have good heat dissipation properties, in addition to good mechanical strength. To meet such demands, it is favorable that the case 6 is made of metal. For example, the constituent material of the case 6 may be aluminum or an alloy thereof, or magnesium or an alloy thereof. These metals (alloys) have good mechanical strength and heat conductivity, and are light-weight and non-magnetic.

The combined body 10 is accommodated within this case 6 so as to satisfy the following conditions (1) and (2).

(1) End faces of the wire-wound portions 2A and 2B on one end side (end faces on the end portions 2a and 2b side) are arranged opposing an inner wall face 6B of the case 6 that is located on the lower left side in FIG. 1.
(2) End faces of the wire-wound portions 2A and 2B on the other end side (end faces on the connecting portion 2R side) are arranged opposing an inner wall face 6B of the case 6 that is located on the upper right side in FIG. 1.

That is to say, the wire-wound portions 2A and 2B are horizontally arranged within the case 6, and the axes of the wire-wound portions 2A and 2B are substantially parallel to a bottom face 6A of the case 6. In this case, out of outer peripheral faces of the wire-wound portion 2B (2A), a face that is located on the outer side in the direction in which the wire-wound portions 2A and 2B are arranged in parallel serves as a case-opposing face 20 that opposes an inner wall face 6B of the case 6 (in FIG. 1, the case-opposing face of the wire-wound portion 2A is located at an invisible position). Also, two out of the four inner wall faces 6B of the case 6, namely faces that are shown on the lower right side and the upper left side in FIG. 1 serve as coil-opposing faces 60 that oppose the case-opposing faces 20.

In addition, in this example, a joint layer 62 is interposed between the bottom face 6A of the case 6 and the combined body 10 (see FIG. 3). This joint layer 62 has a function of transmitting heat generated in the combined body 10 when the reactor 1α is used, to the bottom face 6A of the case 6. The constituent material of the joint layer 62 is insulative. The constituent material of the joint layer 62 may be any of thermosetting resin, which includes epoxy resin, silicone resin, and unsaturated polyester, or thermoplastic resin, which includes polyphenylene-sulfide (PPS) resin and liquid crystal polymer, for example. The heat dissipation properties of the joint layer 62 may be improved by including the aforementioned ceramic filler or the like in such an insulating resin.

### Shape of Wire-Wound Portions, and Positional Relationship Between Wire-Wound Portions and Case

FIG. 3 shows the wire-wound portions 2A and 2B within the case 6 when viewed from an end face side thereof. FIG. 3 omits constituent elements that are not associated with the arrangement state of the wire-wound portions 2A and 2B, such as the end portions 2a and 2b and the connecting portion 2R of the coil 2. Since the shape of the end faces of the wire-wound portion 2A and the shape of the end faces of the wire-wound portion 2B are line-symmetric, the following description takes the wire-wound portion 2B as a representative example.

The wire-wound portion 2B is formed so that an end portion of the case-opposing face 20 on the lower side (i.e. on the bottom face 6A side of the case 6) is closer to the center of the wire-wound portion 2B than an end portion of the case-opposing face 20 on the upper side. For this reason, each end face of the wire-wound portion 2B has a right trapezoidal shape (i.e. the shape indicated by chain double-dashed lines that is similar to a right trapezoid) that has a lower side L1 that opposes the bottom face 6A of the case 6, an upper side L2 that is parallel to the lower side L1, an outer side L3 that connects the lower side L1 to the upper side L2, and faces an inner wall face 6B of the case 6, and an inner side L4 that connects the lower side L1 to the upper side L2 on the side opposite to the outer side L3. Since the outer side L3 is formed by a portion of the case-opposing face 20, the outer side L3 faces the coil-opposing face 60. The wire-wound portion 2B that has the above-described shape can be readily made by adjusting the settings of a wire winding machine. Here, corner portions of the end-face shape that has a right trapezoidal shape are formed by bending the winding wire edge-wise, and are thus rounded.

In the end-face shape of the wire-wound portion 2B, the angle θ between the upper side L2 and the outer side L3 is an acute angle, and the angle φ between the lower side L1 and the outer side L3 is an obtuse angle. The angle between the upper side L2 and the inner side L4 and the angle between the lower side L1 and the inner side L4 are substantially 90°. That is to say, the end-face shape of the wire-wound portion 2B is a right trapezoidal shape, and is also an inverted trapezoidal shape. It is favorable that the angle θ is 85° or more and 89° or less, that is, the angle φ is 91° or more and 95° or less. If the angles θ and φ are within these ranges, it is possible to obtain a wire-wound portion 2B that has substantially the same magnetic characteristics as those of a wire-wound portion whose end faces have a rectangular shape. The angle θ may be 87° or more and 89° or less, and may further be 88.5° or more and 89° or less. The angle φ may be 91° or more and 93° or less, and may further be 91° or more and 91.5° or less.

On the other hand, each coil-opposing face 60 of the case 6 in this example is configured to be perpendicular to the bottom face 6A. For this reason, a relatively large space is formed between a lower end portion of the case-opposing face 20 of the wire-wound portion 2B end side and the coil-opposing face 60 of the case 6. This space increases flowability of the potting resin on the bottom face 6A side when the case 6 is filled with the potting resin, allowing the potting resin to readily spread over the case 6. As a result, cavities are unlikely to be formed in the potting resin, and it is possible to suppress a decrease in the efficiency of dissipating heat from the wire-wound portions 2A and 2B to the case 6 due to cavities.

### Effects of Reactor

The reactor 1α of Embodiment 1 has good heat dissipation properties. This is because, as mentioned above, the end faces of the wire-wound portions 2A and 2B have a trapezoidal shape, and thus cavities are unlikely to be formed in the potting resin.

### Others

Here, the end-face shape of the wire-wound portions 2A and 2B is not limited to a trapezoidal shape, and may alternatively be a circular shape, for example. In this case, the lower side of the circular shape is favorably closer to the center of the wire-wound portions 2A and 2B than the upper side thereof.

### Embodiment 2

Embodiment 2 will describe, based on FIG. 4, a reactor 1β, which differs from the reactor of Embodiment 1 in the configuration of the coil-opposing faces 60 of the case 6. FIG. 4 shows the wire-wound portions 2A and 2B within the case 6 when viewed from an end face side thereof. The configuration of the combined body 10 is completely the same as that of Embodiment 1, and a description thereof will be omitted accordingly.

As shown in FIG. 4, the coil-opposing faces 60 of the case 6 have a shape that is formed following the case-opposing faces 20 of the wire-wound portions 2A and 2B. Specifically, the coil-opposing faces 60 are formed into inclined faces that are further inclined outward of the case 6 on the upper side.

In the configuration in this example, the distance from any position on the case-opposing faces 20 of the wire-wound portions 2A and 2B to the coil-opposing faces 60 of the case 6 is substantially fixed. That is to say, a heat dissipation path from any position on each case-opposing face 20 to the corresponding coil-opposing face 60 has a substantially fixed length, and it is thus possible to reduce unevenness in heat dissipation from the wire-wound portions 2A and 2B, and improve the heat dissipation properties of the reactor 1β.

### Embodiment 3

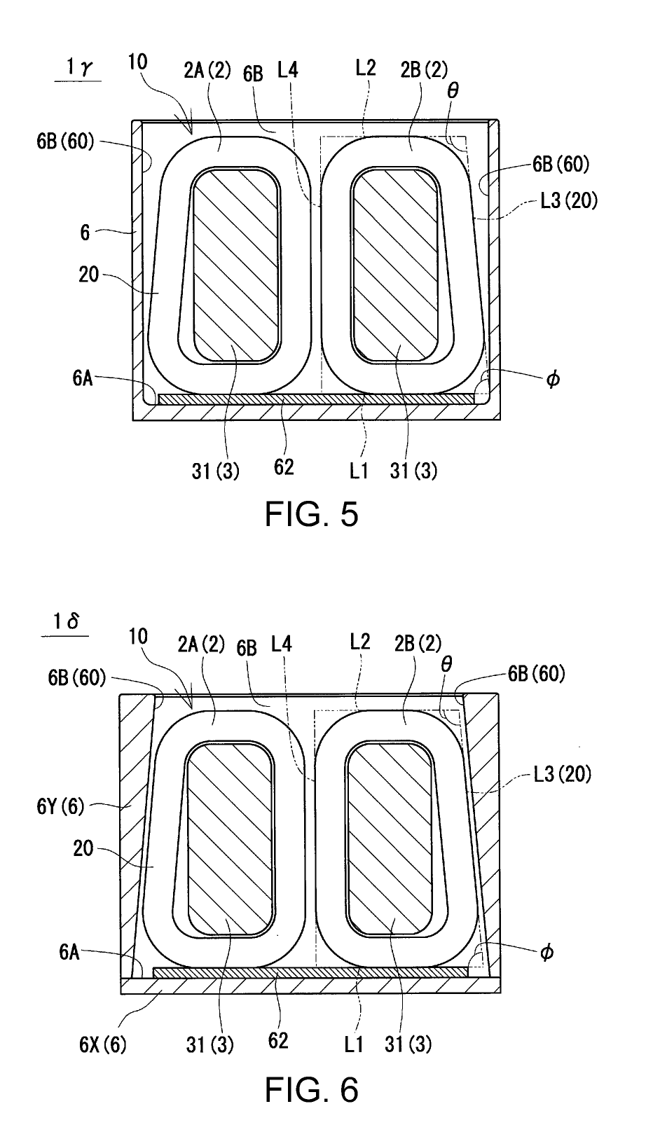

Embodiment 3 will describe, based on FIG. 5, a reactor 1γ with the wire-wound portions 2A and 2B whose end-face shape is vertically inverted, compared with Embodiment 1. FIG. 5 shows the wire-wound portions 2A and 2B within the case 6 when viewed from an end face side thereof.

In the end-face shape of the wire-wound portions 2A and 2B in this example, the angle θ is an obtuse angle, and the angle φ is an acute angle. The angle θ may be 91° or more and 95° or less, or 91° or more and 93° or less, or 91° or more and 91.5° or less. The angle φ may be 85° or more and 89° or less, or 87° or more and 89° or less, or 88.5° or more and 89° or less.

In the configuration in this example, relatively large spaces are formed between upper end portions of the case-opposing faces 20 of the wire-wound portions 2A and 2B and the coil-opposing faces 60 of the case 6. These spaces increase flowability of the potting resin on the opening side of the case 6 when the case 6 is filled with the potting resin, allowing the potting resin to readily spread over the case 6. As a result, cavities are unlikely to be formed in the potting resin, and it is possible to suppress a decrease in the efficiency of dissipating heat from the wire-wound portions 2A and 2B to the case 6 due to the cavities.

Here, the end-face shape of the wire-wound portions 2A and 2B is not limited to a trapezoidal shape, and may alternatively be a circular shape, for example. In this case, it is favorable that the upper side of the circular shape is closer to the center of the wire-wound portions 2A and 2B than the lower side thereof.

### Embodiment 4

Embodiment 4 will describe, based on FIG. 6, a reactor 1δ, which differs from the reactor of Embodiment 3 in the configuration of the case 6. FIG. 6 shows the wire-wound portions 2A and 2B within the case 6 when viewed from an end face side thereof.

The case 6 in this example has a divided structure formed by combining a bottom plate portion 6X with side wall portions 6Y. The space inward of the side wall portions 6Y is wider on the lower side (i.e. bottom plate portion 6X side), and is narrower on the upper side (opening side). The coil-opposing faces 60 of the side wall portions 6Y are inclined faces that extend along the case-opposing faces 20 of the wire-wound portions 2A and 2B.

In the case of accommodating the combined body 10 within the above-described case 6, the combined body 10 can be placed on the upper face of the bottom plate portion 6X, and then, the combined body 10 can be covered by the side wall portions 6Y from above. This accommodating procedure can restrict the wire-wound portions 2A and 2B of the combined body 10 from coming into contact with the inner wall faces 6B of the case 6 and being damaged.

In the configuration in this example, the distance from any position on the case-opposing faces 20 of the wire-wound portions 2A and 2B to the coil-opposing faces 60 of the case 6 is substantially fixed, similarly to Embodiment 2. Thus, it is possible to reduce unevenness in heat dissipation from the wire-wound portions 2A and 2B, and improve the heat dissipation properties of the reactor 1δ.

### Embodiment 5

Embodiment 5 will describe, based on FIG. 7, a reactor 1ε in which the combined body 10 that includes two wire-wound portions within the case 6 is arranged vertically. FIG. 7 is a vertical cross-sectional view of the reactor 1ε.

The combined body 10 is accommodated within the case 6 so that the end faces of the wire-wound portions 2A and 2B on one end side are arranged opposing the bottom face 6A of the case 6. That is to say, the wire-wound portions 2A and 2B are vertically arranged within the case 6, and the axes of the wire-wound portions 2A and 2B are substantially perpendicular to the bottom face 6A of the case 6. In this case, a portion of the outer peripheral face of the wire-wound portion 2B (2A) that opposes an inner wall face 6B of the case 6 serves as the case-opposing face 20. All of the four inner wall faces 6B of the case 6 serve as the coil-opposing faces 60 that oppose the case-opposing face 20.

The wire-wound portions 2A and 2B of the combined body 10 in this example are configured by winding the winding wires so that their radius gradually increases from the bottom face 6A side toward the opening side of the case 6. For this reason, the wire-wound portion 2B, when viewed from a direction perpendicular to its axial direction, has a right trapezoidal shape (i.e. the shape indicated by chain double-dashed lines that is similar to a right trapezoid) that has a lower side L1 that opposes the bottom face 6A of the case 6, an upper side L2 that is parallel to the lower side L1, an outer side L3 that connects the lower side L1 to the upper side L2 and faces an inner wall face 6B (coil-opposing face 60) of the case 6, and an inner side L4 that connects the lower side L1 to the upper side L2 on the side opposite to the outer side L3. Since the outer side L3 is formed with a portion of the case-opposing face 20, the outer side L3 faces the coil-opposing face 60. The wire-wound portion 2B that has the above-described shape can be readily made by adjusting the settings of a wire winding machine. Here, the outer side L3 is formed with outer peripheral portions of respective turns of the wire-wound portion 2B, and accordingly has a stair-like shape.

In the shape of the wire-wound portion 2B when viewed from a peripheral face side, the angle θ between the upper side L2 and the outer side L3 is an acute angle, and the angle φ between the lower side L1 and the outer side L3 is an obtuse angle. The angle between the upper side L2 and the inner side L4 and the angle between the lower side L1 and the inner side L4 are substantially 90°. That is to say, the shape of the wire-wound portion 2B when viewed from a peripheral face side is a right trapezoidal shape, and is also an inverted trapezoidal shape. It is favorable that the angle θ is 85° or more and 89° or less, that is, the angle φ is 91° or more and 95° or less. If the angles θ and φ are within these ranges, it is possible to obtain a wire-wound portion 2B that has substantially the same magnetic characteristics as those of a wire-wound portion that has a rectangular shape when viewed from a peripheral face side.

Meanwhile, the coil-opposing faces 60 of the case 6 have a shape that is formed following the case-opposing faces 20 of the wire-wound portions 2A and 2B. For this reason, in the configuration in this example as well, the distance from any position on the case-opposing faces 20 of the wire-wound portions 2A and 2B to the coil-opposing faces 60 of the case 6 is substantially fixed, similarly to Embodiment 2. Thus, it is possible to reduce unevenness in heat dissipation from the wire-wound portions 2A and 2B, and improve the heat dissipation properties of the reactor 1ε.

### Modification

A configuration may also be employed in which the combined body 10 in FIG. 7 is accommodated within the case 6 while being inverted vertically. In this case, it is favorable that the case 6 has a divided structure, similarly to Embodiment 4. The coil-opposing faces 60 of the case 6 may be perpendicular to the bottom face 6A. Furthermore, the overall shape of the wire-wound portions 2A and 2B is not limited to a rectangular tubular shape, and may alternatively be a circular tubular shape, for example.

### Embodiment 6

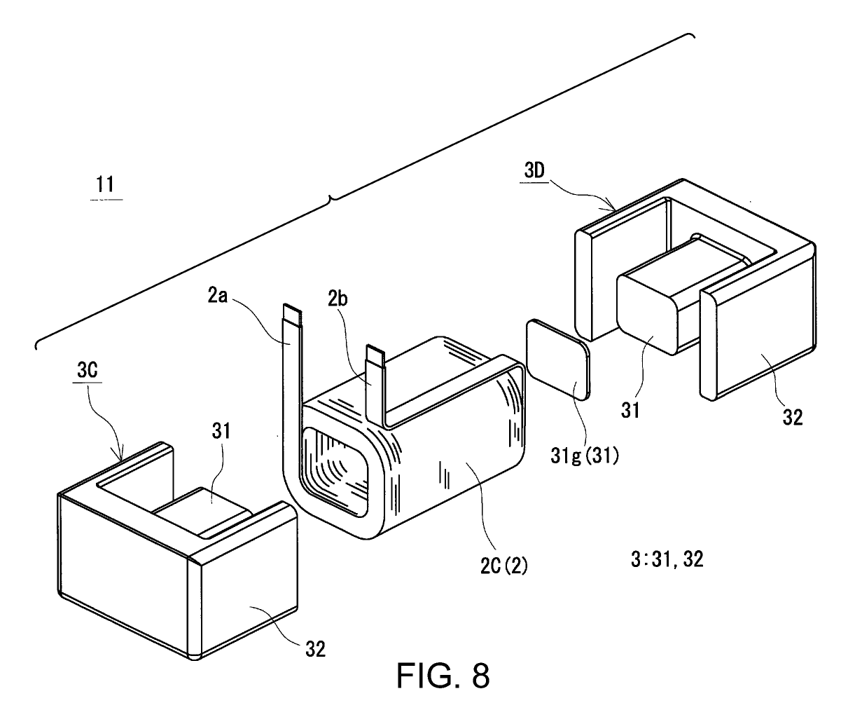

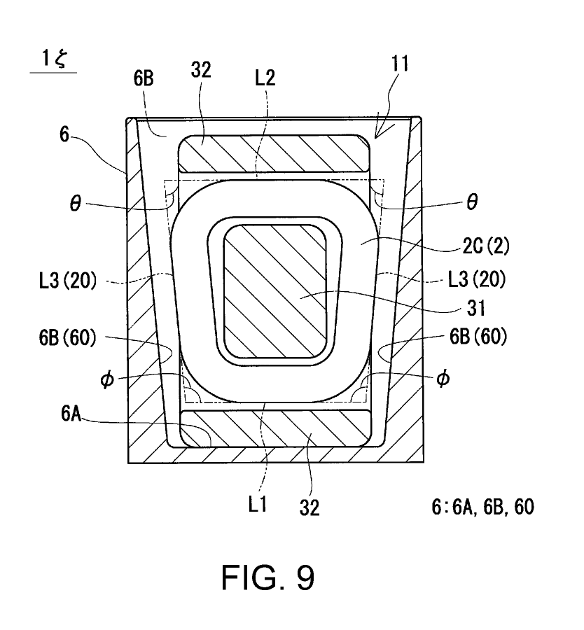

Embodiment 6 will describe, based on FIGS. 8 and 9, a reactor 1ζ in which a combined body 11 with a coil 2 that includes one wire-wound portion 2C is accommodated within the case 6.

FIG. 8 is an exploded perspective view of the combined body 11. The coil 2 of the combined body 11 in this example includes one wire-wound portion 2C, which has a substantially rectangular tubular shape. The direction in which the end portions 2a and 2b of the coil 2 are pulled out is not limited to the direction shown in FIG. 8, and can be changed as appropriate in accordance with the state of the coil 2 accommodated within the case 6 (FIG. 9). The magnetic core 3 of the combined body 11 is constituted by two divided cores 3C and 3D, which are substantially E-shaped when viewed from above, and one gap portion 31g. In this case, an internal core portion 31 is formed with a protruding portion at the center of the E shape of the divided core 3C, a protruding portion at the center of the E shape of the divided core 3D, and the gap portion 31g sandwiched by both protruding portions. An external core portion 32 is formed with portions of the divided cores 3C and 3D other than the protruding portions at the center of the E shape thereof. Needless to say, the divided state of the magnetic core 3 is not limited to the state shown in FIG. 8.

In this example, the combined body 11 in FIG. 8 is rotated by 90° around the axis of the wire-wound portion 2C, and is accommodated in this state in the case 6 (FIG. 9). FIG. 9 shows the wire-wound portion 2C within the case 6 when viewed from an end face side of the wire-wound portion 2C. As shown in FIG. 9, two of the outer peripheral faces of the wire-wound portion 2C serve as the case-opposing faces 20, and two of the four inner wall faces 6B of the case 6 (the inner wall face on the proximal side in FIG. 9 is omitted) serve as the coil-opposing faces 60.

End faces of the wire-wound portion 2C in this example have an isosceles trapezoidal shape (the shape indicated by chain double-dashed lines that is similar to an isosceles trapezoid) that has a lower side L1 that opposes the bottom face 6A of the case 6, an upper side L2 that is parallel to the lower side L1, and a pair of outer sides L3 that connect the lower side L1 to the upper side L2 and face the inner wall faces 6B of the case 6. The angle θ between the upper side L2 and each of the outer sides L3 is an acute angle, and the angle φ between the lower side L1 and each of the outer sides L3 is an obtuse angle. The angles θ and φ may be set in the same ranges as those of Embodiment 1. Here, the left and right angles θ (φ) may be different. That is to say, the end-face shape of the wire-wound portion 2C may not be an isosceles trapezoidal shape.

In the configuration in this example as well, the coil-opposing faces 60 of the case 6 have a shape that is formed following the case-opposing faces 20 of the wire-wound portion 2C. Thus, it is possible to reduce unevenness in heat dissipation from the wire-wound portion 2C, and improve the heat dissipation properties of the reactor 1ζ, similarly to Embodiment 2.

### Modification

A configuration may also be employed in which the combined body 11 in FIG. 9 is accommodated within the case 6 while being inverted vertically. In this case, it is favorable that the case 6 has a divided structure, similarly to Embodiment 4. The coil-opposing faces 60 of the case 6 may be perpendicular to the bottom face 6A. Furthermore, the overall shape of the wire-wound portion 2C is not limited to a rectangular tubular shape, and may alternatively be a circular tubular shape, for example.

### Embodiment 7

Embodiment 7 will describe, based on FIG. 10, a reactor 1η in which the combined body 11 is vertically accommodated within the case 6.

The combined body 11 in this example includes one wire-wound portion 2C, which is configured by winding a winding wire so that the radius gradually increases from the bottom face 6A side toward the opening side of the case 6. For this reason, the wire-wound portion 2C, when viewed from a direction perpendicular to its axial direction, has an isosceles trapezoidal shape (the shape indicated by chain double-dashed lines that is similar to an isosceles trapezoid) that has a lower side L1 that opposes the bottom face 6A of the case 6, an upper side L2 that is parallel to the lower side L1, and a pair of outer sides L3 that connect the lower side L1 to the upper side L2 and face the inner wall faces 6B of the case 6. Since the outer sides L3 are formed by portions of the case-opposing faces 20, the outer sides L3 face the coil-opposing faces 60. The wire-wound portion 2C that has the above-described shape can be readily made by adjusting the settings of a wire winding machine. Here, the outer sides L3 are formed with outer peripheral portions of respective turns of the wire-wound portion 2C, and accordingly have a stair-like shape.

The angle θ between the upper side L2 and each of the outer sides L3 is an acute angle, and the angle φ between the lower side L1 and each of the outer sides L3 is an obtuse angle. The angles θ and φ may be set in the same ranges as those of Embodiment 1.

In the configuration in this example as well, the coil-opposing faces 60 of the case 6 have a shape that is formed following the case-opposing faces 20 of the wire-wound portion 2C. Thus, it is possible to reduce unevenness in heat dissipation from the wire-wound portion 2C, and improve the heat dissipation properties of the reactor 1η, similarly to Embodiment 6.

### Modification

A configuration may also be employed in which the combined body 11 in FIG. 10 is accommodated within the case 6 while being inverted vertically. In this case, it is favorable that the case 6 has a divided structure, similarly to Embodiment 4. The coil-opposing faces 60 of the case 6 may be perpendicular to the bottom face 6A. Furthermore, the overall shape of the wire-wound portion 2C is not limited to a rectangular tubular shape, and may alternatively be a circular tubular shape, for example.

### Embodiment 8

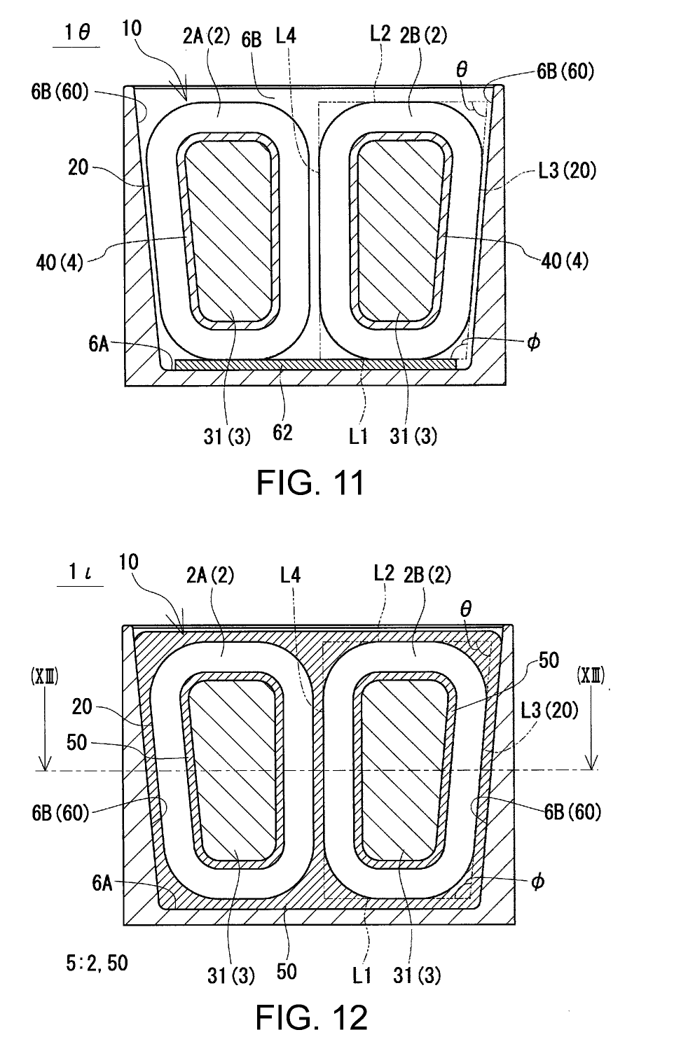

The cross-sectional shape of the internal core portions 31 of Embodiments 1 to 7 (see FIGS. 3 to 7) may be a shape similar to that made by inner outlines of the wire-wound portions 2A and 2B. The cross-sectional shape of the internal core portion 31 of Embodiments 6 and 7 (see FIGS. 9 and 10) may also be a shape similar to that made by an inner outline of the wire-wound portion 2C. Embodiment 8 will describe, with reference to FIG. 11, a reactor 1θ in which the shape and arrangement of the wire-wound portions 2A and 2B and the shape of the case 6 are the same as those of Embodiment 2 (see FIG. 4), and the cross-sectional shape of the internal core portions 31 is similar to the shape made by the inner outlines of the wire-wound portions 2A and 2B. The reactor 1θ in FIG. 11 has a configuration in which the wire-wound portions 2A and 2B are horizontally arranged within the case 6.

FIG. 11 shows the wire-wound portions 2A and 2B within the case 6 when viewed from an end face side thereof. The cross-sectional shape of the internal core portions 31 shown in FIG. 11 is the cross-sectional shape of the internal core portions 31 in an imaginary cross section perpendicular to the axes of the wire-wound portions 2A and 2B of the coil 2. The cross-sectional shape of the internal core portions 31 in this imaginary cross section is smaller than that made by the inner outlines of the wire-wound portions 2A and 2B, and is similar to that made by these inner outlines. Since the shape made by the inner outlines of the wire-wound portions 2A and 2B are smaller than that made by the outer outlines of the wire-wound portions 2A and 2B, and have a shape similar to the outer outlines thereof, it can also be said that the cross-sectional shape of the internal core portions 31 is similar to that made by the outer outlines of the wire-wound portions 2A and 2B.

With the internal core portions 31 that have the above-described shape, the distance from any position on the outer peripheral faces of the internal core portions 31 to the inner peripheral faces of the wire-wound portions 2A and 2B is substantially fixed. Thus, heat is evenly dissipated from the internal core portions 31 to the wire-wound portions 2A and 2B. Moreover, in this example, the distance from any position on the outer peripheral faces of the wire-wound portions 2A and 2B to the coil-opposing faces 60 is also substantially fixed. Thus, heat is also evenly dissipated from the wire-wound portions 2A and 2B to the case 6. For this reason, the reactor 1θ in this example has good heat dissipation properties, and heat generated in the combined body 10 is quickly dissipated to the outside of the case 6.

Here, the cross sections of the internal core portions 31 in FIG. 11 are perpendicular to the magnetic path. The cross sections of the internal core portions 31, which are formed following the inner peripheries of the wire-wound portions 2A and 2B, have an area larger than the cross-sectional area of the internal core portions 31 of Embodiment 2 (see FIG. 4). That is to say, the cross-sectional area of the magnetic paths of the internal core portions 31 in this example is larger than the cross-sectional area of the magnetic paths of the internal core portions 31 of Embodiment 2 (see FIG. 4).

### Insulating Interposing Member

In this example, insulating interposing members 4 for ensuring insulation between the wire-wound portions 2A and 2B and the magnetic core 3 are provided. The insulating interposing members 4 include internal interposing members 40 that are interposed between the inner peripheral faces of the wire-wound portions 2A and 2B and the outer peripheral faces of the internal core portions 31, and end-face interposing members (not shown) that are interposed between the end faces of the wire-wound portions 2A and 2B and the external core portions 32 (see FIGS. 1 and 2). The internal interposing members 40 are formed so that the distance between the outer peripheral faces of the internal core portions 31 and the inner peripheral faces of the wire-wound portions 2A and 2B is kept constant. That is to say, the thickness of the internal interposing members 40 is substantially uniform. The inner peripheral faces of the internal interposing members 40 have a shape that is formed following the outer peripheral faces of the internal core portions 31. The outer peripheral faces of the internal interposing members 40 have a shape that is formed following the inner peripheral faces of the wire-wound portions 2A and 2B. Here, although the internal interposing members 40 in this example cover the entire outer peripheries of the internal core portions 31, the internal interposing members 40 may alternatively cover a portion of the internal core portions 31. For example, in a possible configuration, a hole or the like is provided in a flat face portion of each internal interposing member 40.

The insulating interposing members 4 can be made of any of thermoplastic resin, which includes PPS resin, PTFE resin, LCP, PA resin, PBT resin, ABS resin, and so on, for example. Furthermore, the insulating interposing members 4 can also be made of any of thermosetting resin, which includes unsaturated polyester resin, epoxy resin, urethane resin, silicone resin, and so on. The heat dissipation properties of the insulating interposing members 4 may be improved by including a ceramic filler in such a resin.

### Others

To ensure insulation between the coil 2 and the case 6, it is favorable to fill the case 6 with potting resin, but the case 6 may not be filled with potting resin. In this case, it is favorable to interpose an insulating member between each case-opposing face 20 of the coil 2 and a corresponding coil-opposing face 60 of the case 6. The insulating member may be an adhesive, a heat dissipation sheet, a heat dissipation grease, or the like, for example. An adhesive facilitates fixation of the position of the combined body 10 within the case 6. A heat dissipation sheet and a heat dissipation grease can improve the heat dissipation properties when heat is dissipated from the wire-wound portions 2A and 2B to the case 6.

### Modification

In the configuration in which the wire-wound portions 2A and 2B (2C) are vertically arranged within the case 6, as described in Embodiment 5 with reference to FIG. 7, and in Embodiment 7 with reference to FIG. 10, the cross-sectional shape of the internal core portions 31 in an imaginary cross section perpendicular to the end faces of the wire-wound portions 2A and 2B (2C) on one end side is made similar to that made by the inner outlines of the wire-wound portions 2A and 2B (2C) in the same imaginary cross section.

### Embodiment 9

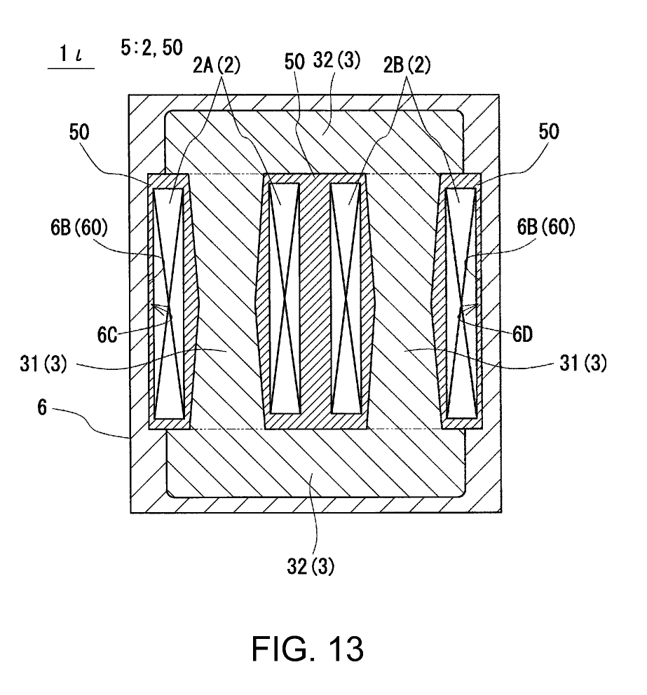

Embodiment 9 will describe, based on FIGS. 12 and 13, a reactor 1ι using a coil molding body 5 that is made of coil mold resin 50 hardened on the outer periphery of the coil 2. FIG. 12 shows the wire-wound portions 2A and 2B within the case 6 when viewed from an end face side thereof, and FIG. 13 is a cross-sectional view taken along a line XIII-XIII in FIG. 12. As shown in FIG. 12, the shape and arrangement of the wire-wound portions 2A and 2B of the reactor 1ι in this example are the same as those of Embodiment 2.

### Coil Molding Body

The coil molding body 5 is formed by covering the outer peripheral faces, inner peripheral faces, and end faces of the wire-wound portions 2A and 2B of the coil 2 (see FIG. 13) with the coil mold resin 50. The coil mold resin 50 of the coil molding body 5 may be any of thermosetting resin including epoxy, and thermoplastic resin including PPS resin and LCP. A filler made of ceramics such as silicon nitride or alumina may also be included in the insulating resin.

The coil molding body 5 may be made by arranging the coil 2 within a mold that has cores to be inserted into the wire-wound portions 2A and 2B, and then injecting the coil mold resin 50 into the mold. In this example, the cores inserted from one end side of the wire-wound portions 2A and 2B abut against the cores inserted from the other end side, at the center of the wire-wound portions 2A and 2B in the axial direction thereof. The cores are tapered toward their leading ends so that the cores can be readily pulled out from the inside of the wire-wound portions 2A and 2B. For this reason, as shown in FIG. 13, the coil mold resin 50 within the wire-wound portions 2A and 2B is thickest at the center portions of the wire-wound portions 2A and 2B in the axial direction, and is thinnest on the end face sides of the wire-wound portions 2A and 2B.

### Case

The case 6 in this example includes a pair of recessed portions 6C and 6D, which are portions of the inner wall faces 6B that are recessed outward, as shown in FIG. 13. One recessed portion 6C and the other recessed portion 6D are provided at opposing positions. The one recessed portion 6C is formed to have a shape into which an outer face of the coil molding body 5 on the wire-wound portion 2A side can be fitted, and the other recessed portion 6D is formed to have a shape into which an outer face of the coil molding body 5 on the wire-wound portion 2B side can be fitted. That is to say, in this example, bottom face portions of the recessed portions 6C and 6D serve as the coil-opposing faces 60. Meanwhile, wall portions of the recessed portions 6C and 6D are substantially in contact with portions of end faces of the coil molding body 5 in the axial direction thereof (which is the same as the axial direction of the wire-wound portions 2A and 2B), and cover these portions of the end faces. The recessed portions 6C and 6D that have the above-described shape enable the coil molding body 5 to be positioned within the case 6 when the coil molding body 5 is arranged within the case 6.

### Magnetic Core

The entire magnetic core 3 in this example is made of a composite material that includes soft magnetic powder and resin. For this reason, as shown in FIG. 13, there is no substantial boundary between the internal core portions 31 and the external core portions 32. Portions arranged within the coil molding body 5 serve as the internal core portions 31, and the other portions serve as the external core portions 32, for convenience. The internal core portions 31 have a shape that is formed following the shape of hollow portions of the coil molding body 5 (i.e. spaces formed within the wire-wound portions 2A and 2B). That is to say, the internal core portions 31 are formed to have a shape that narrows at their center portions in their axial direction. Meanwhile, the external core portions 32 have a shape that is formed following the shape of the inner peripheral faces of the case 6.

### Method of Manufacturing Reactor

The reactor 1ι in FIGS. 12 and 13 can be made as follows. First, the coil molding body 5 is accommodated within the case 6. The coil molding body 5 is attached to the recessed portions 6C and 6D of the case 6 as shown in FIG. 13, and is positioned within the case 6. Next, the case 6, which serves as a mold, is filled with the composite material. The case 6 may be filled with the composite material from a position on an upper end opening of the case 6 at which the external core portion 32 is formed. The composite material that fills the case 6 forms the external core portions 32, and also flows into the hollow portions in the coil molding body 5 to form the internal core portions 31. Here, since the inner walls of the recessed portions 6C and 6D are in contact with portions of the end faces of the coil molding body 5 as shown in FIG. 13, the composite material does not flow toward side faces (faces that are in contact with the coil-opposing faces 60) of the coil molding body 5.

With the above-described method of manufacturing the reactor, the reactor 1ι can be manufactured only by arranging the coil molding body 5 within the case 6 and filling the case 6 with the composite material. Thus, the reactor 1ι can be manufactured with good productivity.

### Modification

The magnetic core 3 of Embodiment 9 can also be configured by combining a plurality of divided cores that are formed using a powder compact. The coil molding body 5 described in this example can also be applied to embodiments other than this example.

### Application of Reactor

The reactor according to a preferred embodiment can be used in a power converter apparatus such as a bidirectional DC-DC converter that is to be mounted in electric vehicles such as hybrid automobiles, electric automobiles, and fuel battery automobiles.

1. A reactor comprising:
a combined body formed by combining a coil that has a wire-wound portion, with a magnetic core; and
a case configured to accommodate the combined body therein,
wherein the wire-wound portion has a case-opposing face that is at least a portion of an outer peripheral face of the wire-wound portion, and opposes an inner wall face of the case, and
wherein a bottom face side of the case is a lower side, and a side opposite to the lower side is an upper side, the wire-wound portion is formed so that one of an end portion of the case-opposing face on the lower side and an end portion of the case-opposing face on the upper side is closer to the center of the wire-wound portion than the other one of the end portion of the case-opposing face on the lower side and the end portion of the case-opposing face on the upper side.

2. The reactor according to claim 1,
wherein the inner wall face of the case has a coil-opposing face that opposes the case-opposing face of the wire-wound portion, and
the coil-opposing face has a shape that is formed following a shape of the case-opposing face.

3. The reactor according to claim 2,
wherein the wire-wound portion is formed so that the end portion of the case-opposing face on the lower side is closer to the center of the wire-wound portion than the end portion of the case-opposing face on the upper side.

4. The reactor according to claim 2,
wherein the wire-wound portion is formed so that the end portion of the case-opposing face on the upper side is closer to the center of the wire-wound portion than the end portion of the case-opposing face on the lower side, and
the case includes a bottom plate portion that constitutes the bottom face, and a side wall portion that has a tubular shape and is attached to the bottom plate portion.

5. The reactor according to any one of claim 1,
wherein the coil includes one wire-wound portion,
an end face of the wire-wound portion on one end side in an axial direction thereof is arranged opposing the inner wall face of the case, and
a shape of the wire-wound portion when viewed from the end face side on the one end side is an isosceles trapezoidal shape that includes a lower side opposing the bottom face of the case, an upper side parallel to the lower side, and a pair of outer sides that connect the lower side to the upper side and face the inner wall face of the case.

6. The reactor according to any one of claim 1,
wherein the coil includes a pair of the wire-wound portions that are arranged parallel to each other,
an end face of each of the wire-wound portions on one end side in an axial direction thereof is arranged opposing the inner wall face of the case, and
a shape of each of the wire-wound portions when viewed from the end face side on the one end side is a right trapezoidal shape that includes a lower side opposing the bottom face of the case, an upper side parallel to the lower side, an outer side that connects the lower side to the upper side and faces the inner wall face of the case, and an inner side that connects the lower side to the upper side on a side opposite to the outer side.

7. The reactor according to any one of claim 1,
wherein the coil includes one wire-wound portion,
an end face of the wire-wound portion on one end side in an axial direction thereof is arranged opposing the bottom face of the case, and
a shape of the wire-wound portion when viewed from a direction perpendicular to the axial direction thereof is an isosceles trapezoidal shape that includes a lower side opposing the bottom face of the case, an upper side parallel to the lower side, and a pair of outer sides that connect the lower side to the upper side and face the inner wall face of the case.

8. The reactor according to any one of claim 1,
wherein the coil includes a pair of the wire-wound portions that are arranged parallel to each other,
an end face of each of the wire-wound portions on one end side in an axial direction thereof is arranged opposing the bottom face of the case, and
a shape of each of the wire-wound portions when viewed from a direction perpendicular to the axial direction thereof is a right trapezoidal shape that includes a lower side opposing the bottom face of the case, an upper side parallel to the lower side, an outer side that connects the lower side to the upper side and faces the inner wall face of the case, and an inner side that connects the lower side to the upper side on a side opposite to the outer side.

9. The reactor according to any one of claim 1,
wherein one of an angle between the upper side and the outer side and an angle between the lower side and the outer side is an obtuse angle that is 91° or larger and 95° or smaller.

10. The reactor according to any one of claim 1,
wherein the magnetic core includes an internal core portion arranged within the wire-wound portion,
an end face of the wire-wound portion on one end side in an axial direction thereof is arranged opposing the inner wall face of the case, and
a cross-sectional shape of the internal core portion in an imaginary cross section perpendicular to an axis of the wire-wound portion is a shape that is similar to the shape made by an inner outline of the wire-wound portion in the imaginary cross section.

11. The reactor according to any one of claim 1,
wherein the magnetic core includes an internal core portion arranged within the wire-wound portion,
an end face of the wire-wound portion on one end side in an axial direction thereof is arranged opposing the bottom face of the case, and
a cross-sectional shape of the internal core portion in an imaginary cross section perpendicular to the end face on the one end side is a shape that is similar to the shape made by an inner outline of the wire-wound portion in the imaginary cross section.
